(19) United States
(12) Patent Application Publication
(10) Pub. No.: US 2021/0166053 A1
(43) Pub. Date: Jun. 3, 2021

(54) MERGING OBJECT DETECTIONS USING GRAPHS

(71) Applicant: Hewlett Packard Enterprise Development LP, Houston, TX (US)

(72) Inventor: Florian Raudies, Palo Alto, CA (US)

(21) Appl. No.: 16/065,279

(22) PCT Filed: Jan. 26, 2016
(86) PCT No.: PCT/US2016/014874

§ 371 Date: Jun. 22, 2018

(51) Int. Cl. G06K 9/46; G06T 7/70

(52) U.S. Cl. CPC G06K 9/469; G06T 2207/20072; G06K 9/4609; G06T 7/70

(57) ABSTRACT

An example embodiment of the present techniques receives a plurality of object detections, each object detection including an identifier. A processor may detect that a threshold number of object detections with a same identifier has been exceeded. The processor may also construct a graph including at least one connected component. Each connected component includes object detections with the same identifier that do not exceed a distance threshold between each other as vertices connected by edges. The processor may also further merge vertices in the connected component to generate a merged detection.

### BACKGROUND

Many situations exist in which objects are detected in space using some n-dimensional coordinate frame and metric. For example, aerial images of an object may result in multiple detections of the same object with two dimensional image coordinates. In some examples, an object may be detected in multiple locations through a four dimensional time-space location.

### BRIEF DESCRIPTION OF THE DRAWINGS

Certain examples are described in the following detailed description and in reference to the drawings, in which:

FIG. 1 is a block diagram of an example system that can filter noise via a graph-based merger of detections;

FIG. 2 is a flow diagram showing an example method of merging detections;

FIG. 3 is a process flow diagram showing another example method of merging object detections;

FIG. 4 is an example system that may filter detection noise via a graph-based merger; and

FIG. 5 is a block diagram showing an example non-transitory, tangible computer-readable medium that stores code for a graph-based merger of detections.

### DETAILED DESCRIPTION

As mentioned above, several applications deal with the merging of detections in space with some associated coordinate frame and metric, Systems or devices that measure object location or quantity may produce several detections in the neighborhood of a true detection. A true detection, as used herein, is a detection that accurately describes the position or state of an object. For example, object detections of the same object can each be defined through 2D image coordinates that originate from multiple aerial images. The multiple object detections then may be merged into a single merged detection. In some cases, a detection can be defined through a 4D space-time location. For example, the same celestial star could be detected in multiple locations, wherein each detection identifies this celestial star and other stars through the spectral composition of the light emitted by each celestial star. Thus, several 4D locations may be merged into a single detection of one celestial star. However, some of these detections may be inaccurate. Accordingly, the present disclosure describes techniques for dropping spurious detections and merging a cluster of detections within a neighborhood into one detection of the same class identifier (ID). A spurious detection may be identified if less than a threshold number of detections of the same class ID occurs. Thus, the techniques herein can be used in any detection systems that need to combine detections in some n-dimensional space. For example, the n-dimensional space can be a coordinate frame where n=3, a space-time where n=4, an image space where n=2, and/or molecules based on periodic table where n≥10. Such detection systems can include instrumentation.

Further, an embodiment of the present techniques includes building a graph of a plurality of received detections. For example, detections may be represented as vertices in the graph connected by edges representing distances and common class IDs between the detections. Moreover, embodiments of the present techniques may merge connected vertices. For example, the present techniques can iteratively join connected vertices until there are no connected vertices left to join. in some examples, a number of detections with a same class ID not exceeding an initial threshold number can be discarded. Thus, the techniques described herein enable spurious detections to be discarded during merging. The present techniques also enable class IDs to be taken into account when merging.

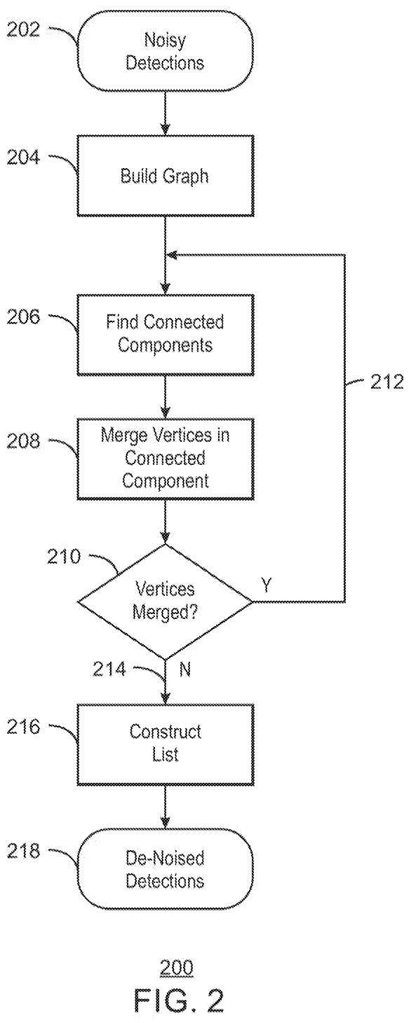

In addition, the present techniques are as computationally efficient as other techniques. For example, as represented in Big O notation, the present techniques have an upper bound of O(n³) operations, Big O notation characterizes functions according to their growth rates; different functions with the same growth rate may be represented using the same O notation. Thus, the present techniques have the same computational complexity as other techniques. In practice, the running time of the present techniques are close to n³/k³ where k denotes the number of connected components. A connected component, as used herein, is a representation of a detected object in a graph that contains several vertices representing detections of the object that are all connected through edges between them. Two distinct connected components in a graph can thus be characterized by having no edge between their vertices, In fact, the loop represented by arrow 212 in FIG. 2 below that iteratively merges connected components may often stop after a single iteration, indicating a running time, as opposed to computational complexity, of closer to O(n²). These embodiments are discussed at greater length with respect to the figures below.

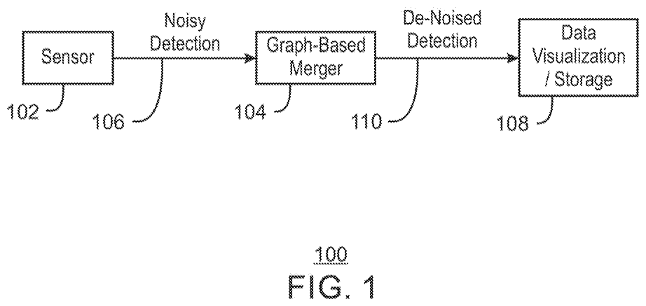

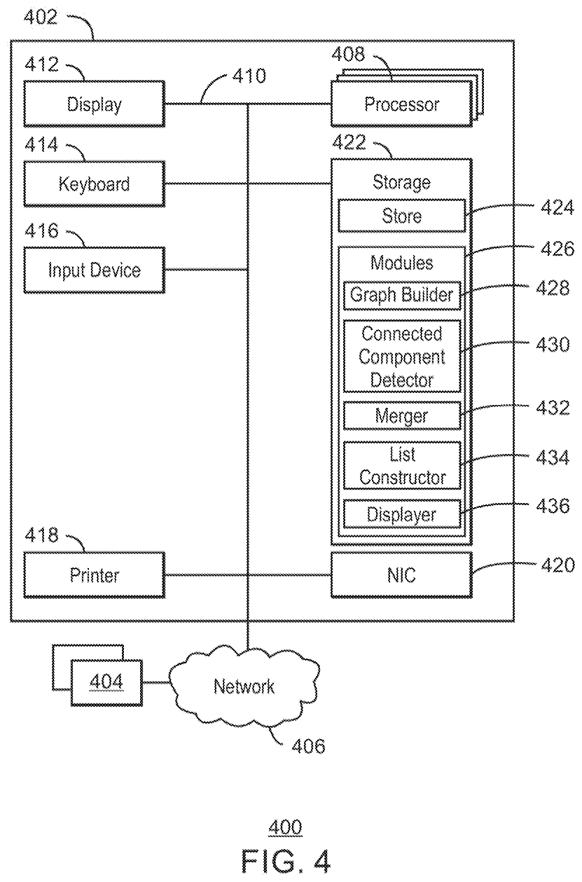

FIG. 1 is a block diagram of an example system that can filter noise via a graph-based merger of detections. The example system is generally referred to be the reference number 100 and can be implemented using the example computing device 402 of FIG. 4 below.

The example system 100 of FIG. 1 includes a sensor 102 connected to a graph-based merger via an arrow 106 representing one or more noisy detections. For example, the sensor 102 can include a camera, clock, depth sensor, and spectrometer, among other types of sensors. The example system 100 also includes a data visualization/storage 108 that is connected to the graph-based merger 104 by an arrow 110 representing one or more de-noised detections. For example, the data visualization/storage 108 can include a map with object detections marked up, or can include 3D display using two monitors and appropriate 3D glasses to visualize the detected geo-location of an object. among other visualizations.

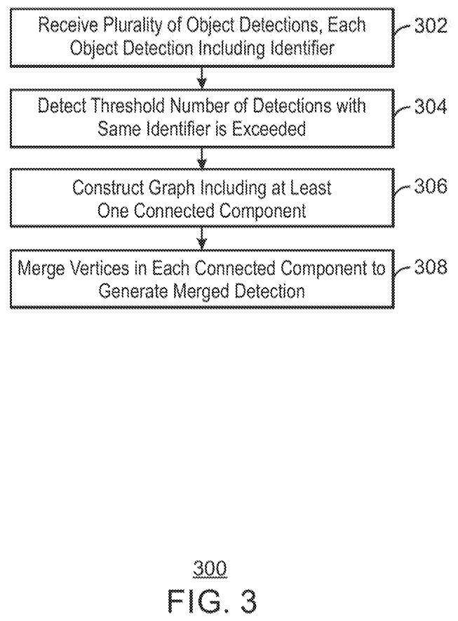

As shown in FIG. 1, the example system may include a sensor 102 capable of generating a plurality of noisy detections. In some examples, the noisy detections may include one or more spurious detections. For example, the same object/element may be detected multiple times at nearby positions or at slightly different sizes or similar objects/elements may be detected within a cluster of correct detections. In some examples, the sensors can register one or more attributes for each detection. For example, the detections can each be associated with a plurality of attributes, including position, size, and an identifier. For example, the identifier can be a class ID. The plurality of noisy detections can be sent to a graph-based merger as indicated by the arrow 108. The graph-based merger 104 may then filter the noisy detections according to the example methods of FIGS. 2-3 below. For example, the detections can he graphed as vertices and merged together based on class IDs and connections as discussed with respect to FIGS. 2-5 below. The graph-based merger can take all these detections, eliminate outliers, and merge multiple, nearby detections of the same object/element. A list of de-noised detections can be sent to the storage 108 as indicated by the arrow 110. In some examples, the de-noised detections can alternatively be visualized directly. For example, the de-noised detections can be displayed on any appropriate display device. Thus, detections having the same ID can be merged based on a threshold number of detections with the same identifier being exceeded and within a threshold distance in a graph. For example, a Jaccard score can be used to measure distance between the detections in the graph. In some examples, detections can be merged by computing a weighted mean size, a weighted mean position, and an arithmetic mean confidence of all detections in a connected component. This merging process can be used to filter out noise in detection systems. The merging process is discussed further in FIG. 2 below.

FIG. 2 is a process flow diagram showing an example method of merging detections. The example method is generally referred to by the reference number 200 and can be implemented using the processor 408 of the example system 400 of FIG. 4 below.

At block 202, a plurality of detected noisy detections may be received from one or more sensors. For example, the noisy detections may include one or more spurious detections and/or multiple detections of a single object. In some examples, each detection may include a plurality of attributes, such as a position, size, and identifier. In some examples, a detection can be defined through coordinates P[j] for j=1 . . . m, where each P is a point in a vector space R^{s}, with s>0. For a two dimensional image space (s=2), the coordinates can be two points P[1] and P[2], which define the upper-left corner of a bounding box and the lower-right corner of a bounding box, respectively. For volumes, and space time, the coordinates can include three or tour points, or other geometric concepts to describe the detection. For example, spheres, among other geometric shapes, can be used to describe the detection. In addition, each detection has an associated class ID, which can be identified by an identifier. For example, all n detections can be indexed by ‘i’ and represented through the lists P[j,i], id[i] for j=1 . . . m and i=1 . . . n, where id is the identifier for the class ID.

At block 204, the processor can build a graph based on the noisy detections. In an example graph, vertices can represent detections and edges between vertices can indicate that these two detections can be merged. The processor maps vertices V with edges E to the detections. An edge E between vertices may be present if the distance between detections is smaller than the maximum dMax and if their associated class IDs are identical.

At block 206, the processor finds all connected components in the graph. For example, the connected components may include vertices representing detections marked for merging. Marking happens by representing these connected components as an independent sub-graph. All vertices within a connected component can then be merged into a single vertex in the subsequent merging step.

At block 208, the processor merges the vertices within a connected component. For example, vertices representing detections can be merged if the corresponding detections have the same identifier, if the detections are close enough with regards to their respective positions, and if the detections are of comparable size, or any combination thereof. In some examples, detections may be merged if their similarity exceeds a predetermined similarity threshold. For example, similarity between detections can be calculated using a Jaccard coefficient. The predetermined similarity threshold can be a predetermined value for the Jaccard coefficient. Two or more vertices of a connected component can be merged by computing the centroid of the corresponding detections' positions and the mean size of these detections to generate a single merged vertex. In some examples, the vertices within a connected component can be joined by computing the weighted mean size, the weighted mean position, and the arithmetic mean confidence value for all vertices within the connected component.

At block 210, the processor determines whether any vertices were merged at block 208. If the processor detects that any vertices were merged within any of the connected components at block 208, then another loop of finding connected components and subsequent merging can be performed as indicated by the arrow 212. In some examples, the merger may be completed with a few iterations of merging. If the processor detects that no vertices were merged at block 208, then the method may proceed at block 216 as indicated by the arrow 214.

At block 216, the processor constructs a list of de-noised detections based on the remaining vertices in the graph. For example, the list of de-noised detections may correspond to detected objects.

At block 218, the processor outputs the list of de-noised detections. For example, the list of de-noised detections can be displayed via a visualization. In some examples, the list of de-noised detections can be saved to a storage.

This process flow diagram Is not intended to indicate that the blocks of the example method 200 are to be executed in any particular order, or that all of the blocks are to be included in every case. Further, any number of additional blocks not shown may be included within the example method 200, depending on the details of the specific implementation.

FIG. 3 is a process flow diagram showing another example method of merging object detections. The example method is generally referred to by the reference number 300 and can be implemented using the processor 408 of the example system 400 of FIG. 4 below.

At block 302, the processor receives a plurality of object detections, each object detection including an identifier. For example, the identifier can include a class ID corresponding to an object.

At block 304, the processor detects a threshold number of detections with a same identifier has been exceeded. For example, a number of detections with the same identifier that exceed a threshold number may correspond to a single detected object.

At block 306, the processor constructs a graph including connected components. Each connected component includes object detections with the same identifier that do not exceed a distance threshold between vertices in the connected component. Such vertices are connected by an edge. For example, the processor may construct the graph based on the plurality of object detections by mapping vertices to the object detections with the edges between the vertices representing a distance between object detections.

At block 308, the processor merges vertices in each connected component to generate a merged detection. In some examples, the processor can merge the vertices if the object detections corresponding to the vertices also further have a size difference less than a threshold difference. For example, the difference may be calculated using a Jaccard score. In some examples, merging the vertices can include repeating the constructing of connected components and the merging of vertices within connected components until no more merging is detected. In some examples, merging the vertices can include computing a centroid of positions of the object detections and a mean size of the object detections to generate a single merged detection of the object over one or more iterations. In some examples, merging the vertices can further include computing a weighted mean size, a weighted mean position, and an arithmetic mean confidence of the object detections.

This process flow diagram is not intended to indicate that the blocks of the example method 300 are to be executed in any particular order, or that all of the blocks are to be included in every case. Further, any number of additional blocks not shown may be included within the example method 300, depending on the details of the specific implementation.

FIG. 4 is a block diagram of an example system that may filter detection noise via a graph-based merger. The system is generally referred to by the reference number 400.

The system 400 may include a computing device 402, and one or more client computers 404, in communication over a network 406. As used herein, a computing device 402 may include a server, a personal compute , a tablet computer, and the like. As illustrated in FIG. 4, the computing device 402 may include one or more processors 408, which may be connected through a bus 410 to a display 412, a keyboard 414, one or more input devices 416, and an output device, such as a printer 418. The input devices 416 may include devices such as a mouse or touch screen. The processors 408 may include a single core, multiples cores, or a cluster of cores in a cloud computing architecture. In some examples, the processor 408 may include a graphics processing unit (GPU). The computing device 402 may also be connected through the bus 410 to a network interface card (NIC) 420. The MC 420 may connect the computing device 402 to the network 406.

The network 406 may be a local area network (LAN), a wide area network (WAN), or another network configuration. The network 406 may include routers, switches, modems, or any other kind of interface device used for interconnection. The network 406 may connect to several client computers 404. Through the network 406, several client computers 404 may connect to the computing device 402. Further, the computing device 402 may access images or detections across network 406. The client computers 404 may be similarly structured as the computing device 402.

The computing device 402 may have other units operatively coupled to the processor 408 through the bus 410. These units may include non-transitory, tangible, machine-readable storage media, such as storage 422. The storage 422 may include any combinations of hard drives, read-only memory (ROM), random access memory (RAM), RAM drives, flash drives, optical drives, cache memory, and the like. The storage 422 may include a store 424, which can include any detections received or generated in accordance with an embodiment of the present techniques. Although the store 424 is shown to reside on computing device 402, a person of ordinary skill in the art would appreciate that the store 424 may reside on the computing device 402 or any of the client computers 404.

The storage 422 may include a plurality of modules 426. For example, the modules 426 may be a set of instructions stored on the storage device 422, as shown in FIG. 4. The instructions, when executed by the processor 408, may direct the computing device 402 to perform operations. In some examples, the graph builder 328, component detector 330, and/or merger 332 may be implemented as logic circuits or computer-readable instructions stored on an integrated circuit such as an Application Specific Integrated Circuit (ASIC), a Field Programmable Gate Array (FPGA), or other type of processor. The graph builder 428 can receive a plurality of detections and build a graph based on the detections, each detection including a class ID corresponding to an object. In some examples, the plurality of detections can include a position, a size, and an identifier. For example, the identifier may include the class ID. The connected component detector 430 can detect connected components in the graph, wherein the connected components each represent that a threshold number of detections with a same class ID has been exceeded and that detections with the same class ID do not exceed a distance threshold between vertices representing object detections. For example, each connected component can include one or more connected vertices corresponding to detections. In some examples, the distance threshold can be a predetermined Jaccard score. The Jaccard score can be computed by dividing the intersecting or overlapping area of object detections, e.g. described through rectangular shapes in two-dimensional space, by the union or overall covered area of object detections,

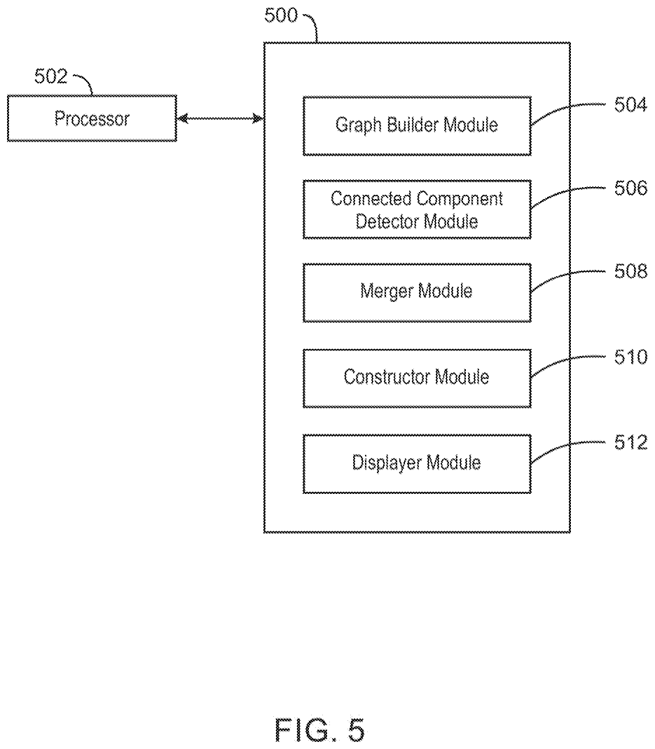

The merger 432 can merge two detections with the same class ID in the graph based on the threshold distance to generate a merged detection. For example, the merged detection can include a weighted mean size, a weighted mean position, and an arithmetic mean confidence of detections represented through vertices within a connected component of the graph. in some examples, the merged detection can include a centroid of positions of the detections and a mean size of the detections. A list constructor 434 can construct a list of merged detections. A displayer 436 can display a list of merged detections in a visualization. For example, the visualization can be a map with object detections marked up, or the visualization can be a 3D display using two monitors and appropriate 3D glasses to visualize the detected geo-location of an object, while providing an option of scrolling through time. The client computers 404 may include storage similar to storage 422. The modules 426 are discussed in greater detail with respect to the example non-transitory, tangible computer-readable medium of FIG. 5 below.

FIG. 5 is a block diagram showing an example non-transitory, tangible computer-readable medium that stores code for a graph-based merger of detections, The non-transitory, tangible computer-readable medium is generally referred to by the reference number 500,

The non-transitory, tangible computer-readable medium 500 may correspond to any typical storage device that stores computer-implemented instructions, such as programming code or the like. For example, the non-transitory, tangible computer-readable medium 500 may include one or more of a non-volatile memory, a volatile memory, and: or one or more storage devices.

Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disks, compact disc drives, digital versatile disc drives, and flash memory devices.

A processor 502 generally retrieves and executes the computer-implemented instructions stored in the non-transitory, tangible computer-readable medium 500 for graph-based merger of detections. A graph builder module 504 can receive a plurality of detections. each detection including a class ID. In some examples, the graph builder module 504 can build a graph based on the detections. A connected component detector module 506 can detect connected components in the graph, For example, the connected components can represent that a threshold number of detections with a same class ID has been exceeded and that detections with the same class ID do not exceed a distance threshold between vertices representing the detections. A merger module 508 can merge detections with the same class ID in the graph based on the threshold distance to generate a merged detection. In some examples, the merger module 508 can compute a weighted mean size, a weighted mean position, and an arithmetic mean confidence of detections represented through vertices within a connected component of the graph. In some examples, the merger module 508 can compute a centroid of positions of the detections and a mean size of the detections to generate a merged detection. In some examples, the merger module 508 can merge the detections if the detections also further have a size difference less than a threshold difference. in some examples, the merger module 508 can detect an outlier detection that is not connected to more than a threshold number of detections with the same class ID and removing the outlier detection from the graph. In some examples, the merger module 508 can calculate a similarity score and merge the detections in response to detecting that the similarity score exceeds a threshold similarity score. A constructor module 510 can construct a list of merged detections. A displayer module 512 can display a list of merged detections in a visualization. In some examples, the displayer module 512 can also store the list of merged detections in a storage.

Although shown as contiguous blocks, the software components can be stored in any order or configuration. For example, if the computer-readable medium 500 is a hard drive, the software components can be stored in non-contiguous, or even overlapping, sectors.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A method for merging object detections, comprising:
receiving a plurality of object detections, each object detection comprising an identifier;
detecting, via a processor, that a threshold number of object detections with a same identifier has been exceeded;
constructing, via the processor, a graph comprising at least one connected component, wherein each connected component comprises object detections with the same identifier that do not exceed a distance threshold between each other as vertices connected by edges; and
merging, via the processor, the vertices in each connected component to generate a merged detection.

2. The method of claim 1, wherein merging the vertices further comprises repeating the constructing of connected components and the merging of vertices within connected components until no more merging is detected.

3. The method of claim 1, wherein merging the vertices further comprises computing a centroid of positions, of the object detections and a mean size of the object detections to generate a single merged detection of the object over one or more iterations.

4. The method of claim wherein merging the vertices further comprises computing a weighted mean size, a weighted mean position, and an arithmetic mean confidence of object detections.

5. The method of claim 1, further comprising merging the vertices representing the object detections if the object detections corresponding to the vertices also further have a size difference less than a threshold difference.

6. A system for noise reduction, comprising:
a graph builder to a receive a plurality of detections and build a graph based on the detections, each detection comprising a class ID corresponding to an object;
a connected component detector to detect connected components in the graph, wherein the connected components each represent that a threshold number of detections with a same class ID has been exceeded and that detections with the same class ID do not exceed a distance threshold between vertices that represent the detections; and
a merger to merge two detections with the same class ID in the graph based on the threshold distance to generate a merged detection

7. The system of claim 6, wherein the merged detection comprises a weighted mean size, a weighted mean position, and an arithmetic mean confidence of detections represented through vertices within a connected component of the graph.

8. The system of claim 6, wherein the merged detection comprises a centroid of positions of the detections and a mean size of the object detections.

9. The system of claim 6, wherein the plurality of detections comprise a position, a size, and an identifier comprising the class ID.

10. A non-transitory, tangible computer-readable medium, comprising code to direct a processor to:
receive a plurality of detections, each detection comprising a class ID;
build a graph based on the detections;
detect connected components in the graph, wherein the connected components represent that a threshold number of detections with a same class ID has been exceeded and that detections with the same class ID do not exceed a distance threshold between vertices that represent the detections;
merge detections with the same class ID in the graph based on the threshold distance to generate a merged detection;
construct a list of merged detections; and
display a list of merged detections in a visualization. The non-transitory, tangible computer-readable medium of claim 10, further comprising code to direct the processor to compute a weighted mean size, a weighted mean position, and an arithmetic mean confidence of the detections represented through the vertices within a connected component of the graph.

12. The non-transitory, tangible computer-readable medium of claim 10 further comprising code to direct the processor to compute a centroid of positions of the detections and a mean size of the detections to generate a merged detection.

13. The non-transitory, tangible computer-readable medium of claim 10, further comprising code to direct the processor to merge the detections if the detections also further have a size difference less than a threshold difference.

14. The non-transitory, tangible computer-readable medium of claim 10, further comprising code to direct the processor to detect an outlier detection that is not connected to more than a threshold number of detections with the same class ID and removing the outlier detection from the graph.

15. The non-transitory, tangible computer-readable medium of claim 10, further comprising code to direct the processor to calculate a similarity score and merge the detections in response to detecting that the similarity score exceeds a threshold similarity score.
